(19) United States
(12) Patent Application Publication
(10) Pub. No.: US 2026/0203619 A1
(43) Pub. Date: Jul. 16, 2026

(54) CONCEPT-AWARE MODEL UNLEARNING VIA MIXTURE OF EXPERTS

(71) Applicant: Cisco Technology, Inc., San Jose, CA (US)

(72) Inventors: Gaowen Liu, Naperville, IL (US); Ramana Rao V.R. Kompella, Foster City, CA (US); Charles Fleming, Oxford, MS (US)

(73) Assignee: Cisco Technology, Inc., San Jose, CA (US)

(21) Appl. No.: 19/021,701

(22) Filed: Jan. 15, 2025

(51) Int. Cl. G06N 5/043; G06N 20/00

(52) U.S. Cl. CPC G06N 5/043; G06N 20/00

(57) ABSTRACT

In one implementation, a device receives, via a user interface, a selection of a concept to be unlearned by an artificial intelligence model. The device identifies a configuration of a gating network in a mixture of experts layer of the artificial intelligence model that is associated with the concept. The device generates a deactivation matrix to disable the configuration of the gating network associated with the concept. The device updates the artificial intelligence model to unlearn the concept by applying the deactivation matrix to the gating network of the mixture of experts layer of the artificial intelligence model.

### TECHNICAL FIELD

The present disclosure relates generally to concept-aware model unlearning via mixture of experts.

### BACKGROUND

Recent advancements in generative artificial intelligence (AI) models have opened new possibilities across various industries. Specifically, the ability of these models to follow instructions enables their integration with tools (e.g., plugins) that are able to perform tasks such as searching the web, executing code, etc. In addition, generative AI have also proven capable of generating content such as images, movies, and audio, to name a few.

The current trend in generative AI is towards versatile models that are capable of performing a wide variety of tasks. However, while versatile model can be beneficial in some instances, there are also cases in which some of the additional capabilities of the resulting model may be undesirable. For instance, a model trained to generate images or video may also be capable of generating sensitive, illegal, biased, copyrighted, or harmful/malicious content, among others. In further cases, it may also be that the capabilities of the trained model exceed the needs of a given deployment, meaning that deployment of the full model will consume additional resources needlessly.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example of a mixture of expert (MoE) layer;

FIG. 6 illustrates an example of the extraction of concepts from an input image;

FIG. 7 illustrates an example of using mixture of experts to unlearn concepts; and

FIG. 8 illustrates an example of a simplified procedure for concept-aware model unlearning using mixture of experts, in accordance with one or more implementations described herein.

### DESCRIPTION OF EXAMPLE IMPLEMENTATIONS

### Overview

According to one or more implementations of the disclosure, a device receives, via a user interface, a selection of a concept to be unlearned by an artificial intelligence model. The device identifies a configuration of a gating network in a mixture of experts layer of the artificial intelligence model that is associated with the concept. The device generates a deactivation matrix to disable the configuration of the gating network associated with the concept. The device updates the artificial intelligence model to unlearn the concept by applying the deactivation matrix to the gating network of the mixture of experts layer of the artificial intelligence model.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

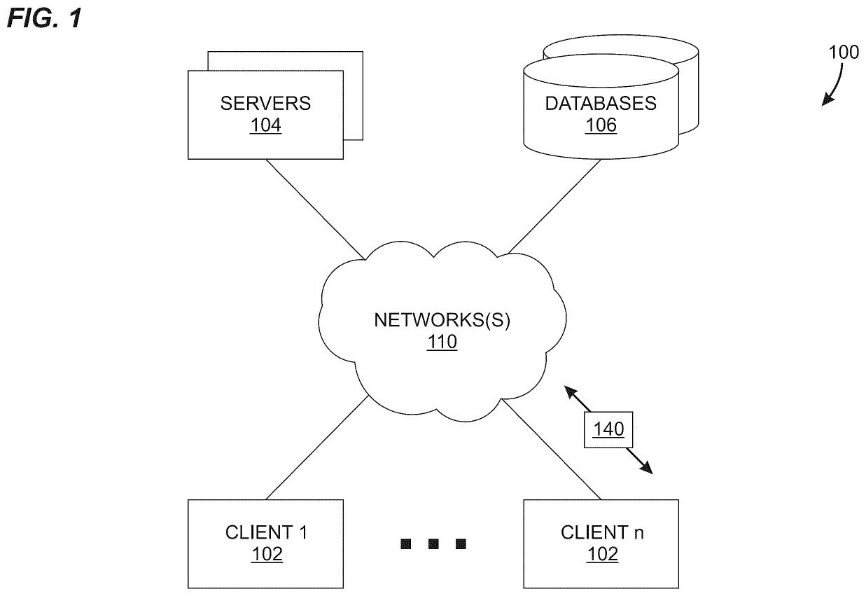

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

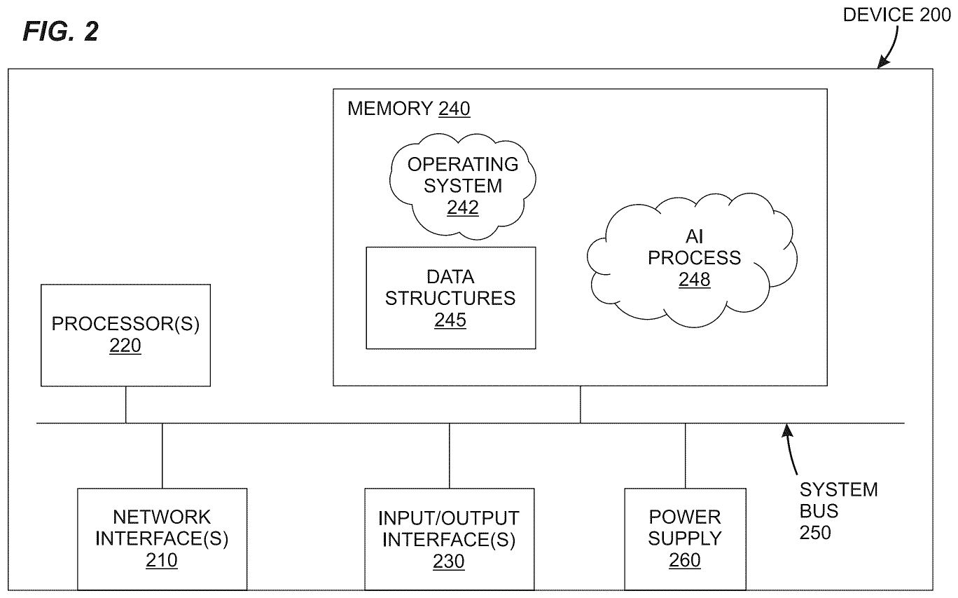

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ and/or be utilized to handle prompts to and/or access of one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

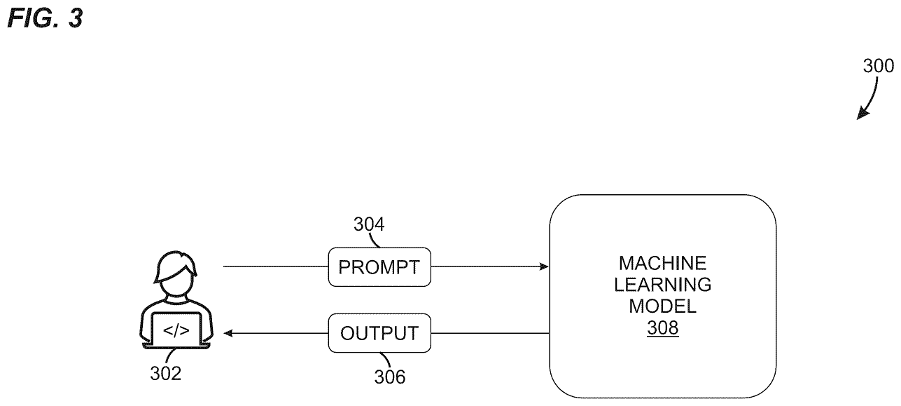

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

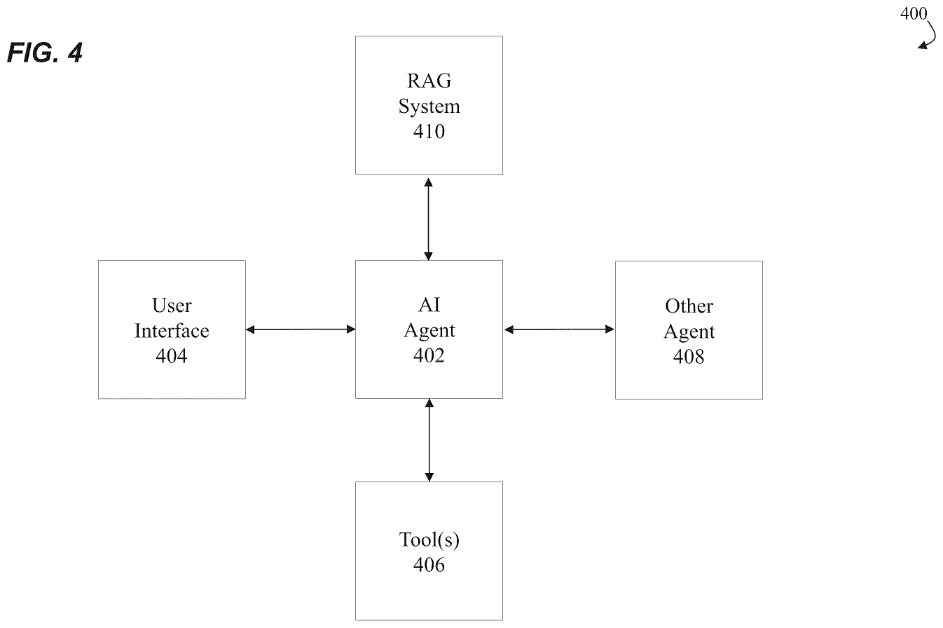

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, the current trend in generative AI is towards versatile models that are capable of performing a wide variety of tasks. However, while versatile model can be beneficial in some instances, there are also cases in which some of the additional capabilities of the resulting model may be undesirable. For instance, a model trained to generate images or video may also be capable of generating sensitive, illegal, biased, copyrighted, or harmful/malicious content, among others. In further cases, it may also be that the capabilities of the trained model exceed the needs of a given deployment, meaning that deployment of the full model will consume additional resources needlessly.

### —Concept-Aware Model Unlearning Via Mixture of Experts—

The techniques herein introduce an approach for model unlearning using a mixture of experts. As would be appreciated, model unlearning generally refers to the act of removing capabilities or knowledge from an already trained AI model. This can be done for various reasons such as removing bias, preventing the model from generating undesirable content, ensuring privacy, improving the performance of the model (e.g., by making the model smaller and lowering latency), and the like.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device receives, via a user interface, a selection of a concept to be unlearned by an artificial intelligence model. The device identifies a configuration of a gating network in a mixture of experts layer of the artificial intelligence model that is associated with the concept. The device generates a deactivation matrix to disable the configuration of the gating network associated with the concept. The device updates the artificial intelligence model to unlearn the concept by applying the deactivation matrix to the gating network of the mixture of experts layer of the artificial intelligence model.

Operationally, the techniques herein leverage mixture of experts (MoE) to achieve model unlearning, according to various implementations. Generally, MoE are a class of transformers that use a MoE layer instead of a traditional feed forward network (FFN) layer. In contrast to FFN layers, which are considered to be dense whereby each token interacts with all of the parameters in an FFN layer, MoE layers instead are considered sparse and each token only actives a subset of one or more ‘experts’ within the MoE layer. More specifically, MoE layers typically include the following:
A learned gating network; and
N-number of experts.

Thus, during processing of a token, the gating network that decides which expert(s) are to process that token. In other words, in the context of transformer models, the gating network effectively serves as a router that determines which tokens are sent to which expert. Example implementations of experts may themselves be FFNs, although other architectures are also possible within an MoE layer, as desired. Typically, the number of experts is relatively small (e.g., fewer than twenty). Because only some of the experts are activated for any given token, training a MoE layer is computationally more efficient than that of an FFN layer. This can also lead to faster processing during inference, as well.

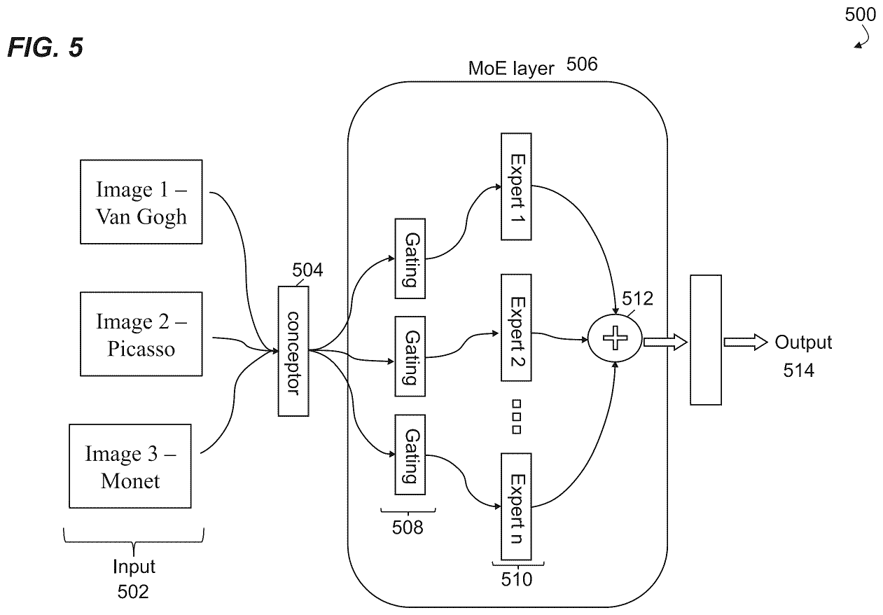

FIG. 5 illustrates an example 500 of a mixture of expert (MoE) layer, in accordance with the teachings herein. As shown, the techniques herein propose a MoE layer 506 that is paired with a conceptor 504 to produce a final output 514 based on input data 502. Here, input data 502 may comprise different types of images, although the techniques herein may be used with any type of input including, but not limited to, text, images, multimodal inputs, or the like.

In various implementations, as described further below, conceptor 504 may be operable to identify those concept(s) present within input data 502. For instance, consider the case in which input data 502 takes the form of images of famous paintings: a first image of a Van Gogh painting, a second image of a Picasso painting, and a third image of a Monet painting. In turn, conceptor 504 may identify concepts represented in each of these images, such as its style (e.g., Van Gogh, Picasso, Monet, etc.), what they depict, and the like. As would be appreciated, conceptor 504 may represent these concepts as vectors, also known as embeddings, which allows for faster processing by an AI model. By representing concepts as vectors, related concepts can also be assigned vector representations that are closer to one another in the embedding space.

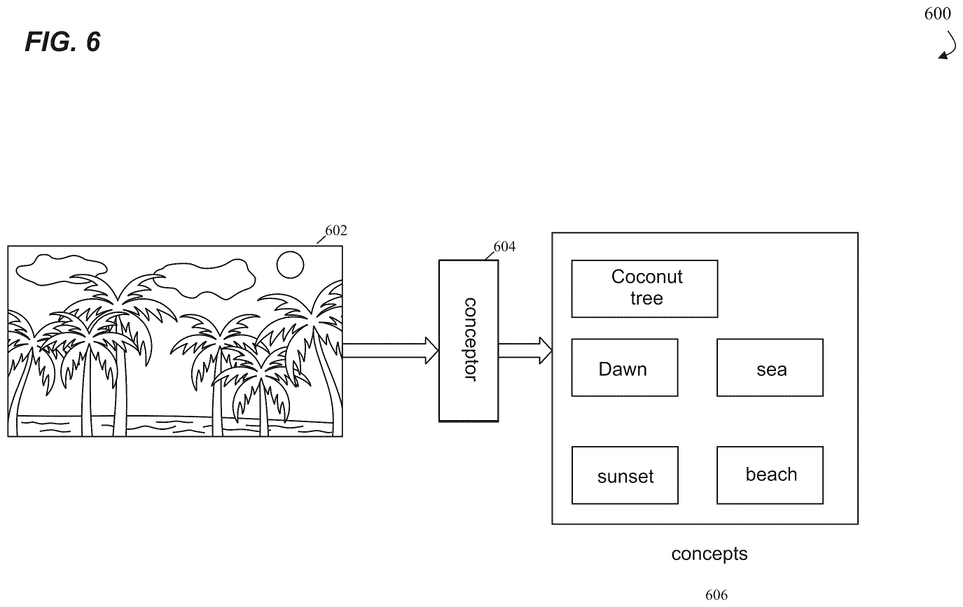

To better illustrate the extraction of concepts from an input image, consider the example 600 shown in FIG. 6. As shown, assume that input image 602 is a picture of a beach. In such a case, conceptor 604 may identify concepts represented by input image 602 such as the following: “coconut tree,” “dawn,” “sea,” “sunset,” and “beach.” Conceptor 604 may represent each of these concepts as embeddings for further processing.

Referring again to FIG. 5, conceptor 504 may provide the concepts that it extracts from input data 502 to gating network 508 of MoE layer 506. Depending on the tokens from conceptor 504 (e.g., the vector embeddings of the extracted concepts), gating network 508 routes them to a selection of experts from the set of experts 510. Each of the selected one or more experts then processes these tokens.

Once the selection from the set of experts 510 has concluded its processing, MoE layer 506 may then employ a combination function 512 to combine their results into a final output 514 of MoE layer 506. For instance, combination function 512 may take the following form:

$$y = {\sum }_{i = 0}^{n} {G ( x )}_{i} {E}_{i} ( x )$$

Here, the gating network (G) decides which experts (E) given the input (x), and the results are combined into the final result (y).

An observation herein with respect to unlearning is that the ability of gating network 508 to route the extracted concepts to the correct selection of experts from set of experts 510 is learned during training of the model. Thus, there is an opportunity to perform unlearning by deactivating those portions of gating network 508 that correspond to a concept being unlearned by the model, according to the teachings herein.

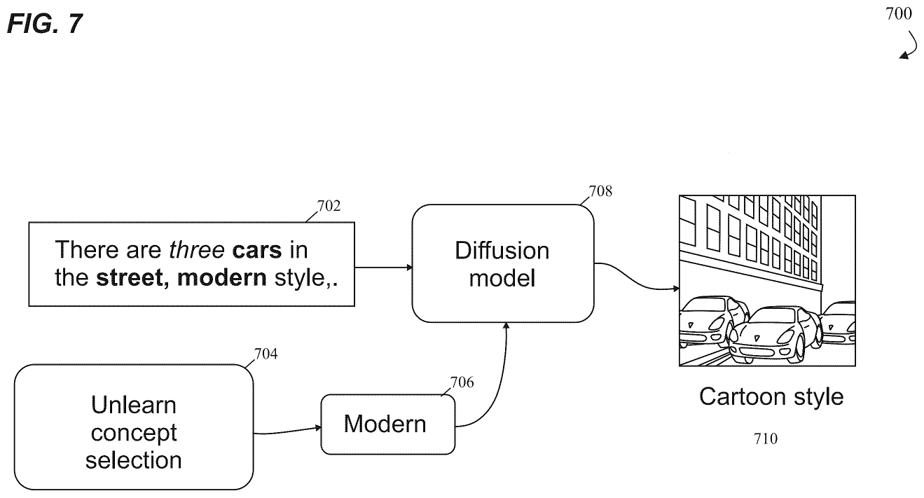

By way of example, FIG. 7 illustrates an example 700 of using mixture of experts to unlearn concepts in various implementations. As shown, consider the case in which diffusion model 708 has been trained to generate images or other content based on the concepts that it extracts from an input prompt. For instance, assume that the user enters a prompt 702 of “There are three cars in the street, modern style . . . ” In such a case, diffusion model 708 may identify the following concepts within prompt 702, based on its prior training: 1.) that the image to be generated should depict three cars, 2.) the cars should be located in a street, 3.) the image should be in a modern painting style, etc.

According to various implementations, the techniques herein may be implemented in conjunction with a user interface that allows a user to specify a selection 704 of a concept that diffusion model 708 is to unlearn. For instance, assume that the user has selected the concept 706, “modern style,” for unlearning. In such a case, the system may perform unlearning of concept 706 on diffusion model 708 by applying a deactivation matrix to its MoE layer and, more specifically, to its gating network. This deactivation matrix will essentially disable the routing of the concept of “modern style” to any of the experts in the MoE layer. In doing so, this removes the ability of diffusion model 708 to generate images in the modern style.

For instance, assume that diffusion model 708 has been trained prior to unlearning on the following concepts:
cars
street
modern style
building
city
cartoon style
etc.

After unlearning, the concept of “modern style” is removed from the capabilities of diffusion model 708. Consequently, given prompt 702, diffusion model 708 may instead generate image 710 that depicts three cars in a street, but using a cartoon style instead of a modern style.

An example of a deactivation matrix that the system could apply to the gating network of diffusion model 708 is as follows: {0, 1, 0, 0, 1}, to deactivate the routing of those gates responsible for routing tokens for the concept of “modern style” to their corresponding experts.

In some implementations, the system may also provide the user with information regarding the performance of the unlearning. For instance, the system may indicate that diffusion model 708 has the following performance metrics, as a result of the unlearning:
Retain accuracy: 91%
Unlearn accuracy: 85%

In further implementations, the system may also allow the user to specify constraints on the unlearning, such as a threshold accuracy that the system is to achieve as a result of the unlearning. If this threshold is not met, the system may even revert the model back to its pre-unlearning state, in some implementations.

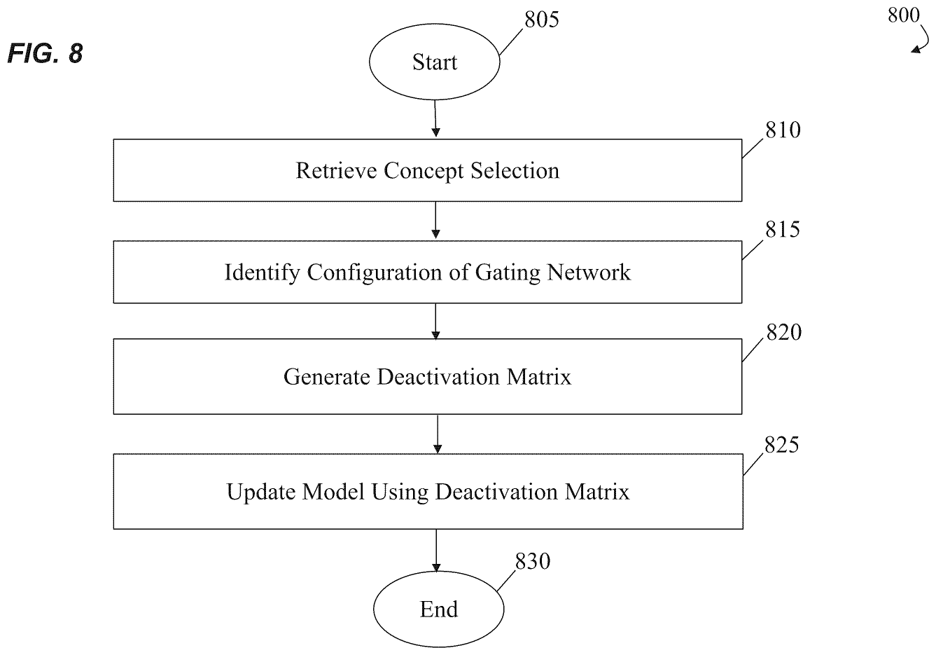

FIG. 8 illustrates an example of a simplified procedure for concept-aware model unlearning using mixture of experts, in accordance with one or more implementations described herein. For example, a non-generic, specifically configured device (e.g., device 200), may perform procedure 800 (e.g., a method) by executing stored instructions (e.g., AI process 248). The procedure 800 may start at step 805, and continues to step 810, where, as described in greater detail above, the device (e.g., a controller, server, etc.) may receive, via a user interface, a selection of a concept to be unlearned by an artificial intelligence model. In one implementation, the artificial intelligence model comprises a large language model (LLM). In another implementation, the artificial intelligence model comprises a diffusion model. In some implementations, the artificial intelligence model takes as input a text-based prompt that indicates one or more concepts. In some implementations, the device may also provide, to the user interface, a listing of concepts on which the artificial intelligence model has been trained for review. In one implementation, the artificial intelligence model is configured to generate images.

At step 815, as detailed above, the device may identify a configuration of a gating network in a mixture of experts layer of the artificial intelligence model that is associated with the concept. In some implementations, the artificial intelligence model represents the concept as a vector embedding. In further implementations, the gating network routes input tokens to feed forward network-based experts within the mixture of experts layer.

At step 820, the device may generate a deactivation matrix to disable the configuration of the gating network associated with the concept, as described in greater detail above. Such a deactivation matrix may cause the gating network to deactivate routing to any of the experts of the MoE layer of the model that are associated with the concept.

At step 825, as detailed above, the device may update the artificial intelligence model to unlearn the concept by applying the deactivation matrix to the gating network of the mixture of experts layer of the artificial intelligence model. In some implementations, the device may further provide an indication of a post-unlearning accuracy of the artificial intelligence model to the user interface. In further implementations, the artificial intelligence model available to users for use after updating it.

Procedure 800 may then end at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for concept-aware model unlearning via mixture of experts, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
receiving, at a device and via a user interface, a selection of a concept to be unlearned by an artificial intelligence model;
identifying, by the device, a configuration of a gating network in a mixture of experts layer of the artificial intelligence model that is associated with the concept;
generating, by the device, a deactivation matrix to disable the configuration of the gating network associated with the concept; and
updating, by the device, the artificial intelligence model to unlearn the concept by applying the deactivation matrix to the gating network of the mixture of experts layer of the artificial intelligence model.

2. The method as in claim 1, wherein the artificial intelligence model comprises a large language model (LLM).

3. The method as in claim 1, wherein the artificial intelligence model comprises a diffusion model.

4. The method as in claim 1, wherein the artificial intelligence model takes as input a text-based prompt that indicates one or more concepts.

5. The method as in claim 1, wherein receiving the selection of the concept comprises:
providing, by the device and to the user interface, a listing of concepts on which the artificial intelligence model has been trained for review.

6. The method as in claim 1, further comprising:
providing, by the device, an indication of a post-unlearning accuracy of the artificial intelligence model to the user interface.

7. The method as in claim 1, wherein the artificial intelligence model is configured to generate images.

8. The method as in claim 1, further comprising:
making, by the device, the artificial intelligence model available to users for use after updating it.

9. The method as in claim 1, wherein the artificial intelligence model represents the concept as a vector embedding.

10. The method as in claim 1, wherein the gating network routes input tokens to feed forward network-based experts within the mixture of experts layer.

11. An apparatus, comprising:
one or more network interfaces;
a processor coupled to the one or more network interfaces and configured to execute one or more processes; and
a memory configured to store a process that is executable by the processor, the process when executed configured to:
receive, via a user interface, a selection of a concept to be unlearned by an artificial intelligence model;
identify a configuration of a gating network in a mixture of experts layer of the artificial intelligence model that is associated with the concept;
generate a deactivation matrix to disable the configuration of the gating network associated with the concept; and
update the artificial intelligence model to unlearn the concept by applying the deactivation matrix to the gating network of the mixture of experts layer of the artificial intelligence model.

12. The apparatus as in claim 11, wherein the artificial intelligence model comprises a large language model (LLM).

13. The apparatus as in claim 11, wherein the artificial intelligence model comprises a diffusion model.

14. The apparatus as in claim 11, wherein the artificial intelligence model takes as input a text-based prompt that indicates one or more concepts.

15. The apparatus as in claim 11, wherein the apparatus receives the selection of the concept by:
providing, to the user interface, a listing of concepts on which the artificial intelligence model has been trained for review.

16. The apparatus as in claim 11, wherein the process when executed is further configured to:
provide an indication of a post-unlearning accuracy of the artificial intelligence model to the user interface.

17. The apparatus as in claim 11, wherein the artificial intelligence model is configured to generate images.

18. The apparatus as in claim 11, wherein the process when executed is further configured to:
make the artificial intelligence model available to users for use after updating it.

19. The apparatus as in claim 11, wherein the artificial intelligence model represents the concept as a vector embedding.

20. A tangible, non-transitory, computer-readable medium storing program instructions that cause a device to execute a process comprising:
receiving, at the device and via a user interface, a selection of a concept to be unlearned by an artificial intelligence model;
identifying, by the device, a configuration of a gating network in a mixture of experts layer of the artificial intelligence model that is associated with the concept;
generating, by the device, a deactivation matrix to disable the configuration of the gating network associated with the concept; and
updating, by the device, the artificial intelligence model to unlearn the concept by applying the deactivation matrix to the gating network of the mixture of experts layer of the artificial intelligence model.
